(19) United States
(12) Patent Application Publication
(10) Pub. No.: US 2007/0255619 A1
(43) Pub. Date: Nov. 1, 2007

(54) INTERNET-BASED PURCHASING AGENT

(76) Inventor: Leon Ekchian, Glendale, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/683,920

(22) Filed: Mar. 8, 2007

Related U.S. Application Data
(60) Provisional application No. 60/780,190, filed on Mar. 8, 2006.

(51) Int. Cl. G06Q 30/00

(52) U.S. Cl. 705/14; 705/26

(57) ABSTRACT

An agent acting on behalf of a single or plurality of reliable customers to provide enhanced bargaining power and economies of scale. The embodiment may screen or classify customer according to reliability metrics, initiate or facilitate contact between customers and retailers, negotiate and/or receive discounted prices for products from retailers and ultimately facilitate purchase of the product by the customer. The embodiment may provide enhanced searching capability for users in order to facilitate purchase or review of products.

### CROSS-REFERENCED TO RELATED APPLICATIONS

The present application claims benefit under 35 U.S.C. §119(e) to U.S. patent application Ser. No. 60/780,190 filed Mar. 8, 2006 and incorporated herein by reference in its entirety.

### TECHNICAL FIELD

The present invention relates generally to online purchasing systems, and more particularly to a purchasing agent providing competitive pricing for a shopper.

### BACKGROUND OF THE INVENTION

Currently, customers generally act individually when they make purchases of goods or services (“products”) on the Internet. As such, the pricing and purchasing structure is disparate and fragmented. Customers may search for a product on the Internet themselves using search engines, such as Yahoo or Google, or using shopping robots (commonly referred to as “bots”). Bots, such as those accessible at websites including pricegrabber.com, froogle.com and mysimon.com, may provide a list of retailers and their respective prices for products. The customer can click on the name of the retailer he/she prefers and is linked to the retailer's website. Subsequently, the customer may elect to purchase the product by providing a credit card number (or other means of payment) and paying the product cost, along with any shipping, handling and applicable taxes. A customer can be an individual, sole proprietorship, small business, school, partnership, corporation or governmental agency (collectively referred to as a “customer”).

Currently, retailers provide information and pricing on products sold on a corresponding website for use by potential customers. In addition, retailers often upload product lists and prices to bots with which the retailers are affiliated. Retailers typically pay a commission to a bot owner for purchases on the retailer's website made by customers referred by the hot. These referrals typically take the form of a link from the bot's search results or webpage to the retailer's Internet store (i.e., website). The customer clicks the link provided by the bot and is transferred to the retailer's website. The retailer's website may record the uniform resource locator (URL) or other identifier referring the customer to the retailer's site. For each referral from a bot, the corresponding commission is paid to the bot owner.

Customers typically decide from which retailer to buy the desired product. This decision may be based on more than simple price. For example, customers may be reticent to select the lowest price retailer if they are not familiar with the retailer. To assist customers, bots may provide ratings of retailers based on cumulative customer feedback. Customer concern about purchasing from unfamiliar retailers is often justified, given the potential for fraudulent transactions. For example, some retailers sell products as brand new when in fact they should be sold as open stock products since they were returned after being opened and used by customers.

On the retailer side of the equation, retail fraud currently poses one of the most critical problems faced by the industry. Recent studies indicate (according to the National Retail Federation) retailers currently lose as much as $16 billion from retail fraud, including, but not limited to, the return of products in spite of extensive use and the cashing of rebate checks despite return of the products. Retailers are reticent to implement drastic, across-the-board restrictions in their return policies so as to not alienate customers.

Accordingly, there is a need in the art for an improved purchasing agent.

### SUMMARY

One embodiment of the present invention takes the form of an agent acting on behalf of a single or plurality of reliable customers to provide enhanced bargaining power and economies of scale. The embodiment may screen or classify customer according to reliability metrics, initiate or facilitate contact between customers and retailers, negotiate and/or receive discounted prices for products from retailers and ultimately facilitate purchase of the product by the customer. The embodiment may provide enhanced searching capability for users in order to facilitate purchase or review of products.

The embodiment may monitor the return frequency, strategy, and return types of various users. If a user's return exceed certain limits, the user may be reclassified in a lower or less-preferred tier of purchaser/member. This, in turn, may affect the discounts available from retailers.

The searching and purchasing functionality of the embodiments described herein may be accessed by a user employing a variety of devices, including mobile telephones and other hand-held, portable devices. This may permit a user, for example, to access prices for a product through the embodiment and compare those prices to those offered by a brick and mortar store in which the user is shopping.

### BRIEF DESCRIPTION OF THE FIGURES

FIG. 1 depicts an exemplary embodiment of the present invention in an exemplary operating environment.

FIG. 2 is a flowchart showing an exemplary membership application procedure.

FIG. 3 is a flowchart showing an exemplary procedure for monitoring a user's product returns.

FIG. 4 is a flowchart showing an exemplary procedure for facilitating return of a product.

### DETAILED DESCRIPTION OF THE INVENTION

One embodiment of the present invention takes the form of an agent acting on behalf of a single or plurality of reliable customers to provide enhanced bargaining power and economies of scale. The agent may be implemented as computing hardware, software, or a combination of both. Such enhanced power and/or economies may be used by the embodiment to facilitate efficiently and securely purchasing products at low prices. The agent provides services accessible via a network which may be provided at a dedicated location or destination, such as a website accessed across or by the network. Exemplary networks suitable for use with embodiments of the present invention include the Internet, an intranet, a wireless network (such as, but not limited to, infrared, radio frequency, ultra-high frequency, very high frequency, and mobile telephone networks), wired networks (such as, but not limited to, a fiber optic network or telephone line network). In certain embodiments the network, or networks, may be accessed by any computing device, mobile computing device, or mobile communications device, including personal computers, mobile telephone, personal digital assistants, and so forth. Possible names for the website include Mybuyer.org, Ourbuyer.com, Idealbuyer.com, Reliablebuyer.com and Truebuyers.com. Accordingly, the term “Truebuyers.com,” as used herein, refers generally to an embodiment of the present invention.

One embodiment may screen or classify customers according to one or more reliability metrics, such as credit score, a metric derived from a number of items purchased and a number of items returned (as described in more detail below), and so on. The embodiment may then, for example, classify certain customers having appropriate metrics as “reliable customers.” As a further example, one embodiment may consider a “reliable customer” to be one that returns a relatively low percentage of purchases. By serving as an agent for reliable customers, Truebuyers.com offers a large pool of customers that are significantly less likely to engage in retail fraud. Retailers in turn may be interested in selling to members of such a pool of frequent and trustworthy buyers represented by a single purchasing agent, namely Truebuyers.com. Consequently these retailers may compete for Truebuyers.com's business by discounting, which may be significant, their prices and providing special benefits and services that typically are not offered to the general public.

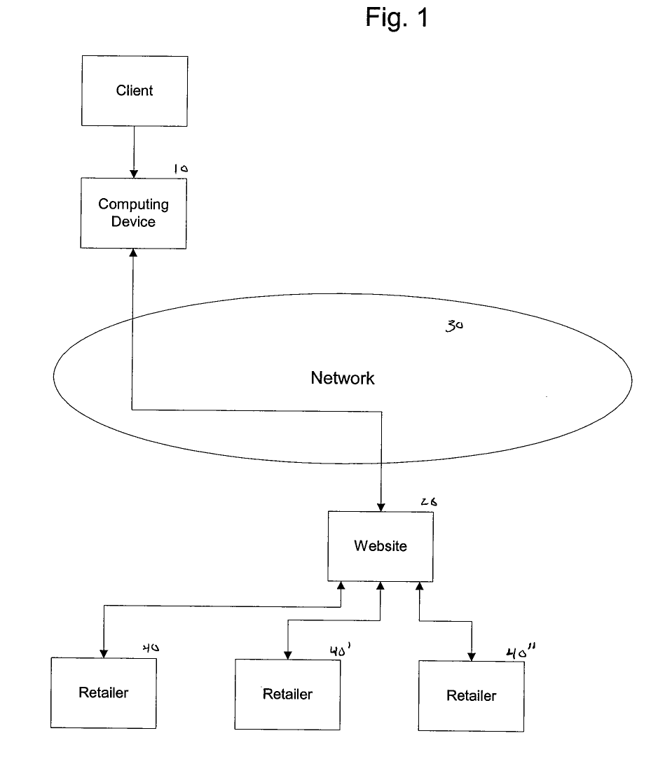

FIG. 1 depicts one embodiment in an exemplary environment. A user may, by employing a computing device 10, access a website (or other information host) 20 across a network 30. The website may include a front end, such as a graphical user interface, permitting the user (via computing device 10) to interact with the website 20. The front end may include, among other things, searching functionality as described below.

The website 20 may also include, or be in communication with, a database. The database may store products and prices provided by one or more retailers 40, 40′, 40″. As also discussed in more detail below, each retailer 40, 40′, 40″ may provide a discount on the price of a product to the website 20. As an alternative, the website 20 may crawl the retailers to determine prices without requiring those prices be transmitted from retailers to the site.

The user may employ the search functionality of the website 20 to determine prices of products from retailers 40, 40′, 40″. These prices may also be affected by the reliability metrics discussed above. As an example, the price of a product from a given retailer 40 may decline as a user's reliability metric becomes more favorable. Different retailers may offer different discounts or different levels of discounts corresponding to reliability metrics.

The terms “customer” and “user” are generally used interchangeably herein.

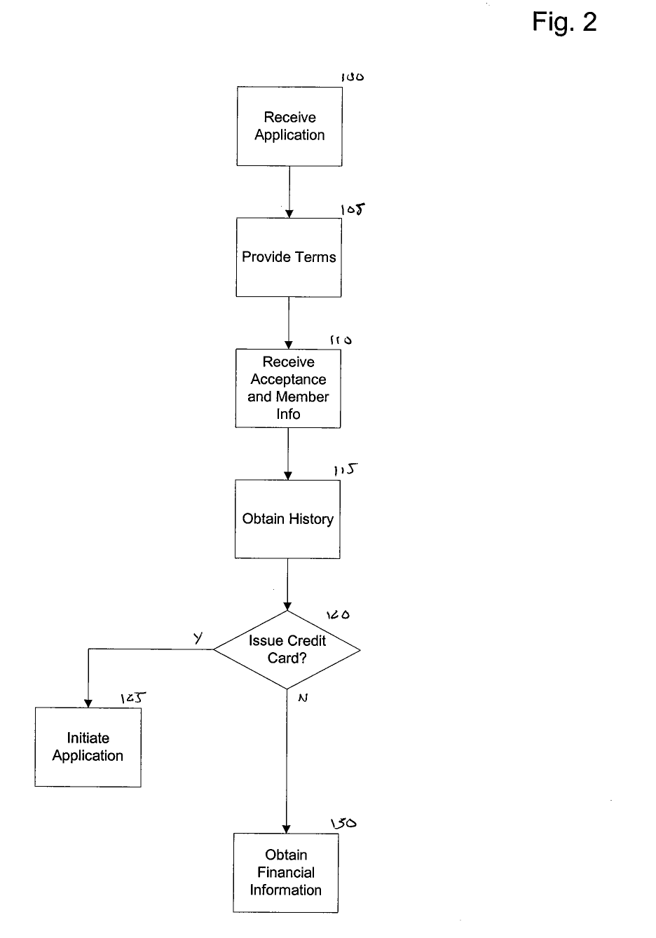

Use of purchasing services provided by one embodiment of the present invention requires membership by a user. FIG. 2 is a flowchart depicting one exemplary method for a user to apply. Application for membership as a purchaser (“user”) can be made on-line at a website. In operation 100, the website 20 (or an affiliated website) receives the application. In operation 105, the embodiment provides membership terms to the user. As an example, an applicant may be advised that they understand that the present embodiment is intended for use by members that pledge to be reasonable and honest customers. If the user agrees to pay the annual membership fee, which may be of any amount desired without departing from the spirit or scope of the present invention, and abide by the bylaws of the association he/she is asked to provide his/her name, address and other appropriate personal information. This information ,along with acceptance of the terms, is received by the embodiment in operation 110. If available, in operation 115 the embodiment may obtain the applicant's past product return history from companies (such as Refund Exchange, Inc.). If this return history is deemed satisfactory, in operation 120 the embodiment may present to the user the option to apply for a Truebuyers.com credit card such a Visa or MasterCard. Upon agreeing, in operation 125 the embodiment may link or send the user to a secure website of a bank that issues credit cards affiliated with the present embodiment and asked to complete a credit card application.

Upon issuance of the optional card the annual membership fee is charged to the member's card and he/she is ready to begin shopping through the present embodiment. While obtaining a Truebuyers.com credit card is not mandatory, it may be encouraged. As additional incentive, the member could be offered a rebate at the end of the year which is a function of the total purchases he/she made using the present embodiment. If an applicant declines the credit card offer, the embodiment may require a user to provide financial information in order to establish credit worthiness in operation 130.

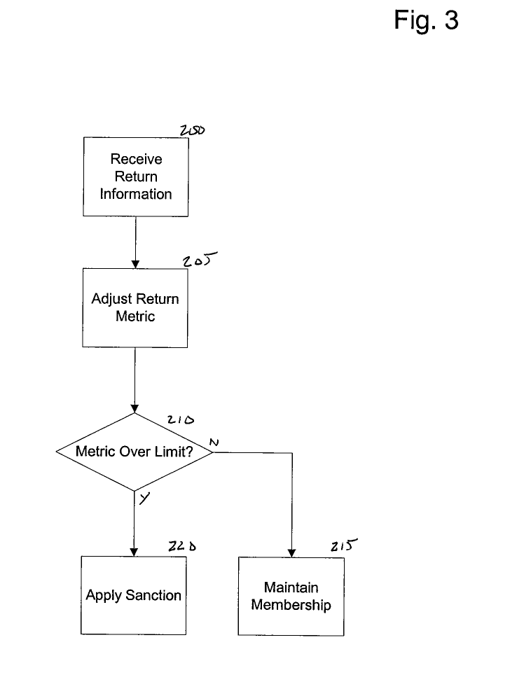

Subsequent to membership, the embodiment may monitor a member's return history to establish return credit score metrics, as shown generally in FIG. 3. In one embodiment, the embodiment initially receives return information from a user or a retailer to which a product is returned. This occurs in operation 200. In operation 205, the embodiment may adjust a return metric, which may be, for example, a function of total returns versus total purchases made by a member. Other appropriate parameters based on statistical information may also be used or may be used in conjunction with the foregoing. In operation 210, the embodiment determines if the return metric is over a certain limit. If not, the embodiment proceeds to operation 215 and the user's membership is maintained without any further action. However, if the embodiment determines in operation 210 that the metric exceeds the limit, then operation 220 is accessed. In operation 220, members who are determined to have too high a return score may have a sanction applied. As examples, the member may be notified and encouraged to minimize future returns, may be assessed a return fee or fine, or may have their membership terminated. Continued abuse of return privileges may ultimately result in the termination or non-renewal of membership privileges.

Multiple membership tiers may also be established, such as platinum, gold and silver. For example, members that maintain return scores in the lowest tier (i.e., those with the most optimal return scores) could be granted platinum status and be afforded greater discounts and privileges. In these manners, the present embodiment provides retailers with an elite group of members who are reliable and reasonable customers. In exchange, retailers would be interested in rewarding Truebuyers.com members and encouraging shopping by offering special discounts and privileges thereto, such as even more liberal return policies for associated users than are available for the general public. As reliability scores (such as return metrics) fluctuate, so too may the membership tier of a user.

Truebuyers.com may have established agreements with many retailers, distributors or manufacturers of products. Examples of retailers include Amazon.com, Office Depot, Home Depot, Nordstrom, Overstock.com, and the outlet stores of manufacturers such as Nike or Jones New York. Examples of manufactures are Sony and HP. Exemplary products include office supplies, computer games, medication, electronics, automobiles, automobile parts, tools, clothing, shoes, insurance, etc. Truebuyers.com may buy from reliable retailers, distributors and manufacturers (hereinafter referred to as “retailers”) that have a good reputation and established customer satisfaction. In some embodiments, vendor reliability metrics (such as customer service and/or satisfaction surveys, price discounting analysis, objective analysis of return policies, and so forth) may be used to classify a retailer as “reliable.” Retailer brochures and prices may be transferred electronically to Truebuyers.com and available for rapid key word or product-type searches. Upon entering the desired product, key word, or product specifications into the search engine of the present embodiment, the member/user is provided a list of different products by brand name that meet the specifications set forth. The products are selected from Truebuyers.com's retailer network, but the name of the retailer need not necessarily be identified to the customer. Next to each brand name is the price that the present embodiment may charge the customer for buying the item on the customer's behalf. As a courtesy, the best price that can be found from other sources on the Internet could also be listed for comparison purposes. The purchase of products is made by Truebuyers.com on behalf of its customers. As a result, Truebuyers.com may realize significant monthly cumulative purchases from each retailer. The large volume of purchases, coupled with providing a pool of reliable and ethical users, provides bargaining power to the present embodiment which may allow for negotiating prices and/or discounts and lower shipping/handling fees. In turn, Truebuyers.com extends a portion of these discounts to its members for each product they purchase using Truebuyer.com.

Once the present embodiment makes a purchase, the corresponding item is shipped directly to the user (i.e. Truebuyers.com member). The retailer is paid by Truebuyers.com, which in turn collects payment (including applicable sales taxes) from the customer. Truebuyers.com does not need to take possession of the item at any point in the transaction, which may minimize inventory carrying costs.

Truebuyers.com acts as the customer's (i.e. Truebuyer.com member's) agent not only during the purchase process, but also if the customer chooses to return a product. Truebuyers.com may negotiate more liberal return policies with its retailers than available to the general public. If the customer chooses to return a product, he/she accesses the relevant purchase record in his account (typically stored by the present embodiment) and selects the appropriate return option. The user/customer may also be asked to provide a reason for the return. If the request is found to be acceptable, a return authorization ticket may be provided electronically for printing by the customer. The request may be automatically evaluated by the present embodiment based on the user's return score, reviewed by an associated customer service professional, or handled in another manner entirely. Once approved, the customer may then attach the return authorization to the box in which the item is being returned and may ship it directly back to the retailer. Truebuyers.com may seek to assist customers who are returning products by establishing preferred rates with companies such as Mailbox, USA and Kinko's for packaging and shipping the products. This may be particularly useful in situations where the original box and packing material in which the products were shipped has been discarded. The provided return authorization may be honored by the retailer because of agreements previously negotiated. Upon confirmation that the returned item was received, Truebuyers.com may credit the customer in full (or partially if the item was damaged or used.) In turn, the retailer may issue a refund to the present embodiment accordingly. For example, such returns could be inputted and/or processed through an electronic form, website, and so forth. However, to dissuade abuse of the liberal return policy, the present embodiment may keep track of the returns made by each customer. In addition, information may be kept as to whether the goods were received damaged or opened. Ultimately, Truebuyers.com may stop acting as the agent for customers abusing the return policy. At that point, such users' membership may be terminated and a prorated annual membership fee may be refunded, or their annual membership may not be renewed.

In instances where the retailer may not accept return of products, Truebuyers.com may note this fact next to the price listed after a search. Thus, there may be two prices for the same item in the instance when returns are not accepted by one retailer. The higher price may be from the lowest price preferred retailer who does accept returns, while the lower price may be from the lowest price preferred retailer which does not accept returns.

The frequent updating of pricing of retailers provides a framework for ensuring the lowest price selection (or a low price selection) by Truebuyers.com from a network of preferred retailers. In effect, the present embodiment conducts a real-time auction, for each purchase request, amongst its retailers. It is also possible for the present embodiment to accept limit buy orders from its customers. For example, a customer may request the purchase of a particular item as soon as the price drops below a certain dollar amount. If desired, the customer may specify that he/she instructs Truebuyers.com to purchase the item without reconfirming the order. In this manner, customers can benefit from special prices that become available without having to check on its status daily or weekly.

In a preferred embodiment of the invention, users purchase products directly from preferred retailers selected by or affiliated with the present embodiment. It is preferable, but not necessary, for all Truebuyers.com members to have affiliated credit cards. After entering a User ID and password, members may search for products of interest. The price displayed to the customer is the retailer price listed on their website, discounted by at least a portion of the overall Truebuyers.com discount negotiated with the retailer. If the customer decides to purchase the product he/she is given the choice of at least one of the following two options. First, the user may authorize Truebuyers.com to act as his/her agent and purchase the product on the member's behalf (optionally using his/her affiliated credit card) or other credit card or payment method requested by the member. This option is particularly convenient if the member has selected several products and placed them in the present embodiment's shopping cart. The present embodiment can automatically, conveniently and instantaneously complete the purchase of the products in the member's shopping cart from all the retailers it identified as the lowest preferred retailer of each product selected.

Secondly, the user may be serially linked to each retailer of a product in his/her shopping cart to complete the purchase using a suitable means of payment. After each purchase, the user may be directed back to the present embodiment's website to in turn be linked to the next retailer for purchase of the next item in the member's shopping cart. Shipping and handling charges and applicable taxes may be added and the products(s) scheduled for shipment by each retailer for either option listed above. In the case of either option disclosed above, the retailer may credit as a commission to Truebuyers.com any remaining portion of the total discount on the product. Members have little incentive to circumvent Truebuyers.com by going directly to the retailer, since such members would not receive the discounted price from the retailer and may lose any end-of-year bonuses given to members. Such bonuses may be a function of the amount of total purchases made.

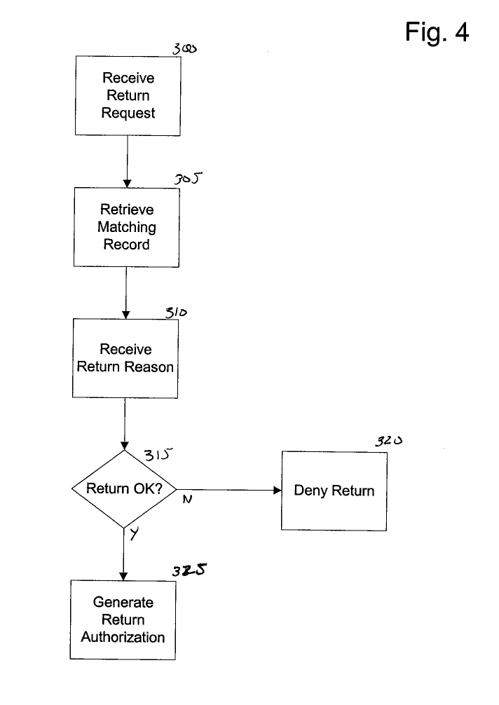

If a user chooses to return a product, the embodiment may initiate the exemplary return process shown in FIG. 4. First, in operation 300, the embodiment receives a return request. The request may be generated, for example, by a user accessing a purchase record in his/her account at Truebuyers.com. In response thereto, the embodiment may retrieve the record matching the return request in operation 305 for display to the user and/or further processing. The user may select the appropriate return option from a list of options, may generate a free-form reason for return, or may provide both. The return option/reason is received by the embodiment in operation 310.

In operation 315, the embodiment determines if the request satisfies the return policy guidelines established with the particular retailer from whom the item was purchased. If so, the embodiment proceeds to operation 325 and generates a return authorization ticket. This ticket may be provided electronically to the user for printing. If, however, the request does not satisfy the particular retailer's request, the embodiment denies the return in operation 320.

Presuming the return authorization was generated, the customer may attach the return authorization to the box in which the item is being returned and may ship it directly back to the retailer. Truebuyers.com may seek to assist customers who are returning products by establishing preferred rates with companies (such as Mailbox, USA and Kinko's) for packaging and shipping the products. This may be particularly useful in situations where the original box and packing material in which the products were shipped has been discarded. The return authorization may be honored by the retailer because of previously-negotiated agreements. Upon receiving confirmation from its receiving department that the returned item was received, the retailer may credit the customer in full or partially if the product was received damaged or excessively used and in turn the present embodiment may refund the commission originally received from the retailer at the time of the purchase.

The operations of FIG. 4 may be performed simultaneously with those of FIG. 3. Alternatively, the embodiment may require a determination in operation 210 that the user's return metric does not exceed a limit prior to initiating the procedure of FIG. 4. As still another alternative, the operations of FIG. 4 may be required to complete before the procedure of FIG. 3 may be initiated.

It is also possible to establish a procedure whereby customers seeking to return a product may directly contact the retailer for return authorization. If granted, the product may be shipped directly back to the retailer. Upon receipt, inspection and acceptance the customer's credit card may be credited in full or partially if the product was received damaged or excessively used. The retailer may notify the present embodiment that one of its members returned a product. The retailer may, for example, complete an electronic return form or may speak to a customer service agent associated with the present embodiment. In turn, the present embodiment may refund the retailer the commission received at the time of the original purchase. Under both approaches outlined above, the user's account may be updated to reflect the return. In this manner, the present embodiment may be able to update the return score of the member. Membership of users that fail to maintain good credit or product return criteria may be terminated or not renewed.

Although the invention is primarily focused on providing efficient Internet commerce between honest customers and reputable retailers, it also may provide benefits for in-store shopping by Truebuyers.com members at preferred retailer stores. Truebuyers.com may negotiate discounts for its members at such stores. Upon presenting proof of membership, or a Truebuyers.com credit card, the member's portion of the discount can be immediately deducted from a listed or discounted store purchase price. Subsequently, the retailer may credit the present embodiment for at least a portion of the discount, which may be refunded back to the retailer if the product is returned. The present embodiment may thus be able to monitor purchases and any returns and in turn update each member's return score.

Another in-store benefit of the present embodiment is real-time comparison of an Internet price for a product against a price he/she can buy the product for in a store. A user of the present embodiment who is shopping in a store may access the associated website by using devices accessing to the Internet, such as portable computers, PDAs, and cell phones. The product information may be manually entered, such as by being typed in, or through voice input. The present embodiment may also provide members with a special phone number, which may be toll free, to verbally request the price negotiated by the present embodiment for a specific product (as described above). The present embodiment may communicate to its member the lowest price that he/she can buy the same product using the present embodiment. The member can then make the decision as to whether to buy the product in the store or purchase through the present embodiment. Purchase through the embodiment may be conducted during the same communication in which the user received price information from the embodiment.

Another embodiment of the present invention permits a retailer to monitor the purchases and returns of its customers in the retailer's stores and/or website. This may be done by software designed to monitor the purchases, returns and other pertinent statistical information. Customers that are deemed to be abusing the return policies may be asked to no longer shop at the store, may be informed when purchasing a product that they may face more stringent return policies, or be denied returning the product altogether. In addition, by monitoring the purchases and returns, retailers may also choose to reward those customers that do not abuse their return policies by granting additional discounts or bonuses. Retailers that issue their own store credit cards can easily track the purchase and returns made by customers that used their store cards in the transactions.

As one example, the following sequence of steps illustrates the exemplary operation of an embodiment of the invention:

Customer accesses the present embodiment and enters his/her user ID and password.

The customer is shopping for a dozen red long stem roses to be delivered no later than the day before Valentine's Day. The customer is also shopping for an inkjet printer. The customer enters his/her search parameters and required delivery time.

The present embodiment determines which of its preferred retailers of flowers (e.g. FTD.com, 1800flowers.com, etc.) is offering the best price and, optionally, an acceptable delivery time. That price is displayed to the customer and the customer is informed whether the item can be returned. In this example, the customer is unaware which florist would be shipping the roses but is generally aware of the preferred list of florists used by the present embodiment. The customer is also provided with a list of inkjet printers by manufacturer (e.g. Hewlett-Packard, Epson, etc.), model number, and specifications (e.g. printing speed) and the lowest price of each available for purchase. The customer is again unaware who the retailer of each model is (it may in fact be different retailers). In addition, the customer is informed what the return policy is for each printer. Again, the return policy may vary, retailer to retailer, although the present embodiment may attempt to establish uniform by policies as much as possible.

The member selects the flowers and a particular model inkjet printer and selects to purchase both, which are then added to his/her shopping cart. The member authorizes the present embodiment to handle the purchase of the flowers and the printers and, optionally, to use an affiliated credit card information on file in his account. The present embodiment automatically and electronically contacts both retailers on behalf of its member and completes the transactions. The flowers and the printer are shipped directly to the member by the respective retailers.

To assist in resolving any problems such as delayed shipments, the present embodiment may establish customer service assistance, either on-line or using a special 800 number, and in turn contact the retailer on behalf of its members. The present embodiment can leverage the substantial total annual purchases by its associated members at each preferred retailer to receive more prompt attention to the resolution of problems.

The Truebuyers.com website can also provide general product information and announcements. In addition, retailers and other parties can advertise their products, services and special promotions. This may provide the present embodiment additional sources of revenue. Manufacturer recalls or product warnings may also be posted by the present embodiment as needed. In addition, to providing the service of purchasing to its members, the present embodiment provides the capability to research products and links to product manufacturer or service provider sites to assist in making the purchasing decision. The present embodiment may also be able to provide up to date information on the latest trends and health related news for its membership. Information on sporting events and shows can be provided along with the ability to purchase the tickets at the lowest price available from Truebuyers.com's retailers. The present embodiment may also provide its customers the ability to conveniently print tickets locally that it purchased on their behalf.

For additional convenience for its members and to attract new members, the present embodiment may establish procedures whereby its price for a product may be displayed by bots. By clicking an icon, a potential customer may be directed to the website associated with the present embodiment. If the potential customer is already a Truebuyers.com member, he/she can proceed with making the purchase. If he/she is not a member he/she may be provided information on Truebuyers.com and the steps to follow to become a member and subsequently maintain membership. Bots may be compensated for linking potential customer to Truebuyers.com.

Embodiments of the present invention may employ websites for display of information to retailers, users, and so forth, search engines to gather prices, means of electronic communication to convey pricing, product lists, communications, and so forth from retailers to the embodiment, databases to store product records, customer records, return scores, and any other relevant information. In short, the present embodiment, its operations, and component systems may be implemented as one or more computing systems configured to perform the specific functions and processes described herein, or as computer-readable instructions for the same.

I claim:

1. A method for providing pricing information associated with a product, comprising:
receiving from a requester, across a network, a request for the pricing information associated with the product;
retrieving at least one price from at least one retailer for the product, the at least one price reflecting a discount associated with a membership status; and
presenting the at least one price as the pricing information; wherein
the membership status is based at least in part on a reliability metric associated with the requester.

2. The method of claim 1, wherein the reliability metric is derived from a number of items purchased by the requester and a number of items returned by the requester.

3. The method of claim 1, wherein the network is a telephone network.

4. The method of claim 1, further comprising:
retrieving at least a second price for the product, the second price not reflecting the discount associated with a membership status; and
presenting the second price to the requester.

5. A method for facilitating purchase of a product, comprising:
receiving, from a requester across a network, a request for a price of the product;
determining a retailer price charged by a retailer for purchase of the product on the Internet;
providing to the requester the retailer price;
presenting to the requester an option to purchase the product for the retailer price; and
in the event the requester desires to purchase the product for the retailer price, initiating purchase of the product at the retailer price; wherein
a purchase of the product at the retailer price occurs at least partially over the Internet;
the requester may indicate a desire to purchase the product for the retailer price via the network; and
the network is at least partially a mobile telephone network.
